(19) United States
(12) Patent Application Publication
(10) Pub. No.: US 2025/0187101 A1
(43) Pub. Date: Jun. 12, 2025

(54) METHOD AND APPARATUS FOR MITIGATING RISK OF LIQUID METAL EMBRITTLEMENT DURING RESISTANCE WELDING

(71) Applicant: FCA US LLC, Auburn Hills, MI (US)

(72) Inventors: Bryan J Macek, Rochester Hills, MI (US); George V Fantazian, White Lake, MI (US); Steven P Gucciardo, Brighton, MI (US)

(21) Appl. No.: 18/536,873

(22) Filed: Dec. 12, 2023

(51) Int. Cl. B23K 11/14; B23K 11/11; B23K 11/34

(52) U.S. Cl. CPC B23K 11/14; B23K 11/115; B23K 11/34

(57) ABSTRACT

A method of joining two sheets includes providing a first sheet of material of non-liquid metal embrittlement susceptible material, providing a second sheet of material of liquid metal embrittlement susceptible material and forming a projection on first sheet. The method further comprises placing the second sheet and the projection of the first sheet between electrodes of a welder and welding the first sheet to the second sheet at the projection.

### FIELD

The present disclosure relates to resistance welding of metallic sheets, and more particularly, to a method and apparatus for reducing liquid metal embrittlement during welding.

### BACKGROUND

This section provides background information related to the present disclosure which is not necessarily prior art.

Advanced High Strength Steels (AHSS) are commonly used to produce automotive structures that are both lightweight and provide robust safety performance. The alloy chemistry and heat treatment used to produce these steels, particularly grades with retained austenite for improved formability, can be susceptible to the formation of liquid metal embrittlement (LME) cracks during welding if one or more of the sheets involved in the joint are coated with zinc or zinc-alloy for corrosion resistance. LME can occur on susceptible steel grades, typically high strength grades containing retained austenite to improve ductility. LME can be detrimental to weld strength. LME is most detrimental at the faying surface (where the sheets are joined) or in a heat affected zone at or near the weld nugget. LME more likely occurs with a small diameter face on the weld electrodes.

Current solutions involve elimination of zinc coating, use of a large face diameter electrode cap or use of a complex weld schedule to minimize the occurrence of and effects of LME cracking. However, elimination of zinc coating leads to unacceptable corrosion performance in many parts of a vehicle, limiting the use of LME susceptible steel. Use of a large face diameter electrode cap does not fully eliminate LME cracking and may prohibit welding of thinner material, which is detrimental to the goal of reducing vehicle mass. Use of a complex weld schedule increases development time and may increase welding cycle time.

### SUMMARY

This section provides a general summary of the disclosure and is not a comprehensive disclosure of its full scope or all of its features.

In one aspect of the disclosure, a method of joining two sheets includes providing a first sheet of material of non-liquid metal embrittlement susceptible material, providing a second sheet of material of liquid metal embrittlement susceptible material and forming a projection on first sheet. The method further comprises placing the second sheet and the projection of the first sheet between electrodes of a welder and welding the first sheet to the second sheet at the projection.

In another aspect of the disclosure, a method includes providing a first sheet of material of non-liquid metal embrittlement susceptible material, providing a second sheet of material of liquid metal embrittlement susceptible material, providing a third sheet of material of liquid metal embrittlement susceptible material and forming a first projection on first sheet in a first direction. The method further includes forming a second projection on the first sheet in a second direction opposite the first direction, placing the first sheet between the second sheet and the third sheet so that the first projection is adjacent the second sheet and the second projection is adjacent the third sheet, placing the first projection between electrodes of a welder, placing the second projection between the electrodes of a welder and welding the first sheet to the second sheet and the third sheet.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations and are not intended to limit the scope of the present disclosure.

FIG. 1A is a side view of an LME susceptible sheet and a non-LME susceptible sheet prior to being joined at one projection by a resistance welder.

FIG. 1B is a side view of an LME susceptible sheet and a non-LME susceptible sheet joined at one projection by the resistance welder.

FIG. 2A is a side view of an LME susceptible sheet and a non-LME susceptible sheet prior to being joined at two projections by the resistance welder.

FIG. 2B is a side view of an LME susceptible sheet and a non-LME susceptible sheet joined at two projections by the resistance welder.

FIG. 3A is a side view of an LME susceptible sheet and a non-LME susceptible sheet prior to being joined at three projections by the resistance welder.

FIG. 3B is a side view of an LME susceptible sheet and a non-LME susceptible sheet joined at three projections by the resistance welder.

FIG. 3C is a top view of a non-LME susceptible sheet with three projections.

FIG. 4A is a side view of two non-LME susceptible sheets prior to being joined together with a non-LME susceptible sheet therebetween.

FIG. 4B is a side view of two non-LME susceptible sheets joined together with a non-LME susceptible sheet therebetween.

FIG. 5 is a method of forming a weld to reduce LME.

Corresponding reference numerals indicate corresponding parts throughout the several views of the drawings.

### DETAILED DESCRIPTION

Example embodiments will now be described more fully with reference to the accompanying drawings.

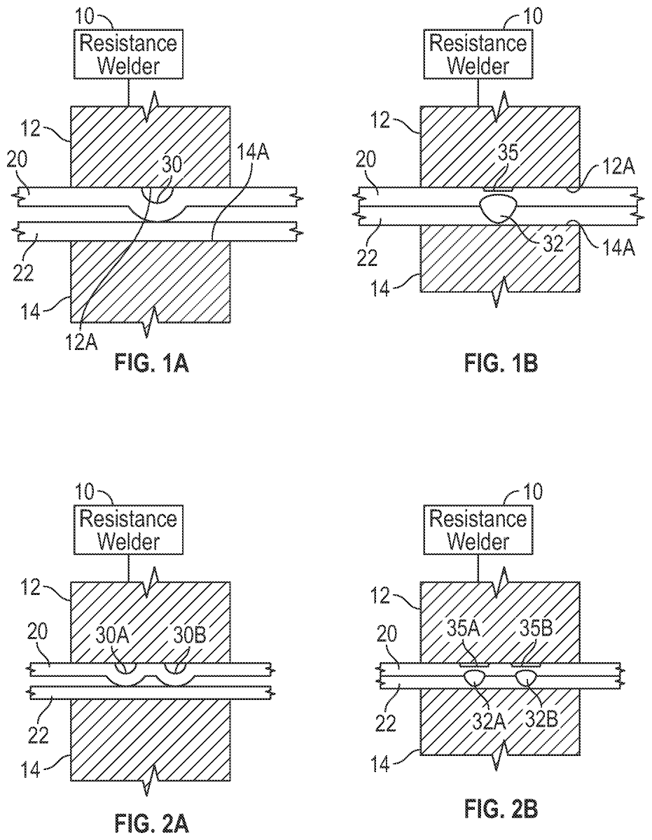

Referring now to FIGS. 1A and 1B, a resistance welder 10 is illustrated having a first electrode 12 and a second electrode 14. To perform resistance welding, an electrical current is passed between the electrodes 12, 14 and through the material to be welded that is placed therebetween. In this example, the electrodes 12, 14 are flat electrodes that have flat bottoms 12A and 14A, respectively that contact the planar surfaces of the parts to be joined. The electrodes 12, 14 are cylindrical in nature.

A first metallic sheet 20 and a second metallic sheet 22 are to be joined together in FIG. 1A. The first metallic sheet 20 is a non-liquid metal embrittlement susceptible material. That is, the first metallic sheet 20 is not susceptible to liquid metal embrittlement (LME). The second sheet 22 is formed of a material that is susceptible to liquid metal embrittlement. The first sheet 20 and the second sheet 22 are formed of steel and are advanced high strength steel, high strength low alloy steel or ultra-high strength steel in this example. Advanced high strength steel has a tensile strength between 590 MPa and 1180 MPa. Ultra-high strength steel has a tensile strength greater than 1180 MPa and up to 2000 MPa in tensile strength. The microstructure of the sheets 20, 22 may have two different phases such ferrite, martensite, bainite, austenite or the like. Both sheets are zinc coated in the present example. The first sheet 20 may be thicker than the second sheet 22. The first sheet 20 may be the same thickness as the second sheet 22. Likewise, the first sheet 20 may be thinner than the second sheet 22.

A projection 30 is formed in the first sheet which is a non-LME susceptible material. The projection 30 may be stamped into the first sheet 20. Stamping may take place using cold forming, warm forming or hot forming. Cold forming is performed at ambient temperature. Warm forming is performed between ambient and 60% of the melting temperature of the sheet 20 in degrees Kelvin. Hot forming is performed at greater than 60% of the melting temperature of the sheet 20 in degrees Kelvin. As will be described below, the projection 30 may be elongated within the weld area.

The electrodes 12, 14 pass a current through the projection 30. The projection 30 allows concentrated current to flow between the electrodes 12, 14 through to the second sheet 22. As shown best in FIG. 1B, a weld nugget 32 is formed during the resistance welding process. Likewise, the projection 30 is flattened completely or a small discontinuity or gap 35 may be formed at the area of the projection. During welding, the current through the projection 30 may be up to 35 kiloamps, in this example.

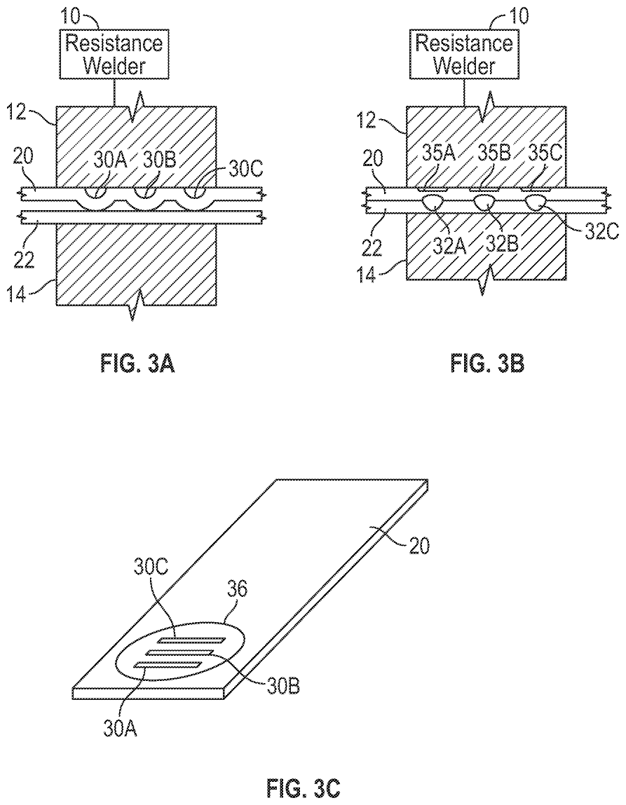

Referring now to FIGS. 2A and 2B, more than one projection 30A, 30B is used to join materials similar to that described above. In FIGS. 1A and 1B, one projection was used for the thinnest sheet thickness of between 0.7 mm-1.0 mm. In FIGS. 2A and 2B, the finished material is between 1.1 mm and 1.7 mm so two projections 30A and 30B are used. The respective weld nuggets 32A and 32B are formed between the projections 30A, 30B and the second sheet 22 and may possibly form gaps 35A, 35B as described above.

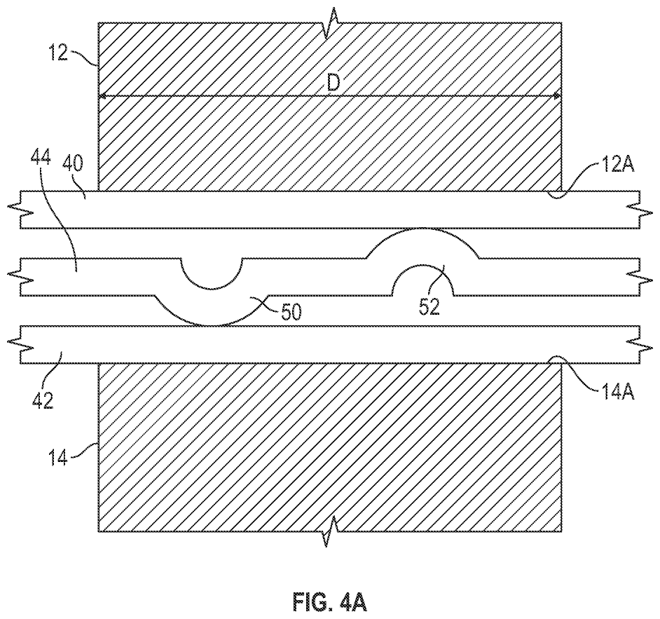

Referring now to FIGS. 3A, 3B and 3C, three projections are illustrated in a weld area 36. The weld area 36 is illustrated in FIG. 3C is where the electrodes 12, 14 are positioned during the formation of the nuggets during the welding process. In this example, three projections 30A, 30B and 300 are formed so that nuggets 32A, 32B and 32C are formed during the welding process between the projections 30A-C and the second sheet 22. Gaps 35A-35C are formed adjacent to where the projections 30A-C were. In one example, the number of projections is determined by the thickness of the governing metal which is the thinner of the sheets to be welded.

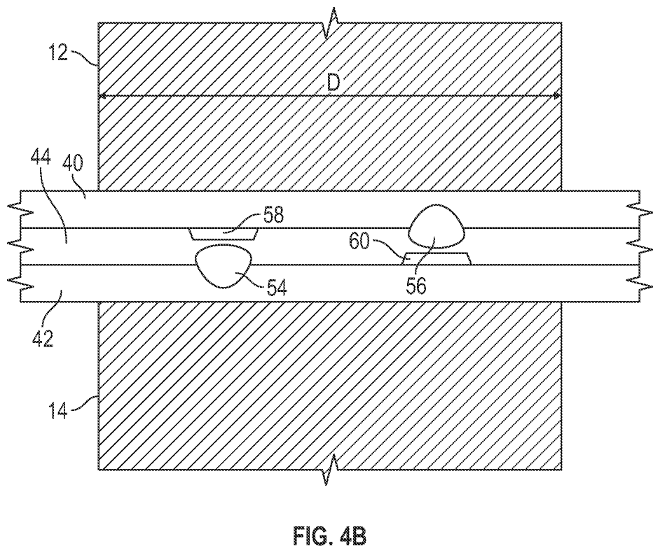

Referring now to FIGS. 4A and 4B, in the preceding examples, one LME susceptible sheet is joined with the non-LME susceptible sheet. In FIGS. 4A and 4B, two LME susceptible sheets are to be joined together. In this example, a third sheet 44 may be disposed therebetween which is formed of non-LME susceptible metal. In a similar manner to that described above, a first projection 50 is formed in the direction of the second sheet 42 so that a weld nugget 54 is formed between the projection 50 and the second sheet 42.

The first sheet 40 is joined to the second sheet 44 at a projection 52 which extends in the opposite direction as the projection 50. A weld nugget 56 is formed between the projection 52 and the first sheet 40 during the weld process. The projections 50, 52 may be spaced apart small enough to be within the diameter D of the electrodes 12, 14. That is, the welding formation of the nuggets 54, 56 take place simultaneously in one example. However, simultaneously formation of the nuggets 54, 56 is not required. Therefore, two separate weld operations may form the projections 50, 52 so that the nuggets 54, 56 are formed at different times in the second example. Layer 44 may also be thinner than both sheets 40, 42 and may be referred to as intermediate layer. Gaps 58, 60 may form at the site of the projections 50, 52, respectively on opposite sides of the sheet 44.

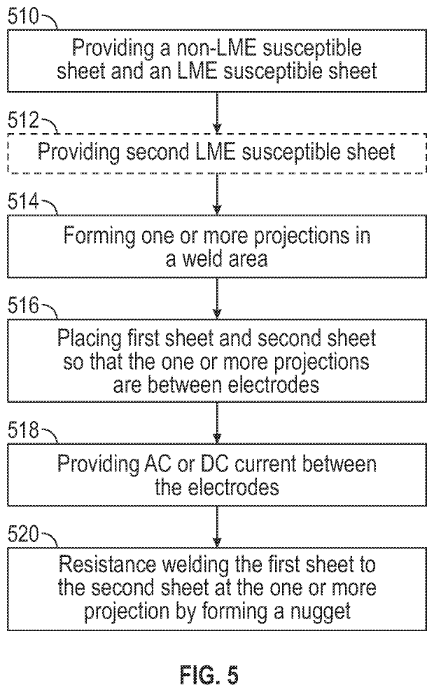

Referring now to FIG. 5, a method for forming the assembly of FIGS. 1-4 is set forth. In this example, a non-LME susceptible sheet of material such as steel and an LME susceptible sheet of material such as steel is provided. In step 512, an optional step of providing a second LME susceptible sheet is set forth. The use of another LME susceptible sheet corresponds to FIG. 4 where two LME susceptible sheets are joined.

In step 514, one or more projections are formed in a weld area non-LME susceptible sheet. When two LME susceptible sheets are to be joined, the projections may extend in opposite directions as illustrated in FIG. 4. The number of projections when a non-LME susceptible and an LME susceptible sheet are to be joined together depends on the thickness of the thinnest sheet as mentioned above relative to FIG. 2. In step 516, the first sheet and the second sheet are positioned so that one or more projections are placed between the electrodes. In step 518, the resistance welder provides an AC or DC current between the two electrodes so that current is concentrated at each of the projections. Each of the projections may allow up to 35 kiloamps to be passed through each projection. In step 520, the first sheet is resistance welded to the second sheet at the one or more projections by forming a nugget therebetween. When a second LME susceptible sheet is provided, step 520 forms a nugget between the non-LME susceptible sheet and the second LME susceptible sheet.

Example embodiments are provided so that this disclosure will be thorough and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method comprising;
providing a first sheet of material of non-liquid metal embrittlement susceptible material;
providing a second sheet of material of liquid metal embrittlement susceptible material;
forming a projection on first sheet;
placing the second sheet and the projection of the first sheet between electrodes of a welder; and
welding the first sheet to the second sheet at the projection.

2. The method of claim 1 wherein forming the projection comprises forming a plurality of projections.

3. The method of claim 1 wherein providing the second sheet comprises providing the second sheet thicker than the first sheet.

4. The method of claim 1 wherein providing the second sheet comprises providing the second sheet thinner than the first sheet.

5. The method of claim 1 wherein providing the second sheet comprises providing the second sheet with a same thickness as the first sheet.

6. The method of claim 1 wherein forming the projection comprises forming an elongated projection.

7. The method of claim 1 wherein forming the projection comprises cold forming the projection.

8. The method of claim 1 wherein forming the projection comprises warm forming the projection.

9. The method of claim 1 wherein forming the projection comprises hot forming the projection.

10. The method of claim 1 wherein welding the first sheet to the second sheet at the projection comprises forming a weld nugget between the projection and the second sheet.

11. The method of claim 1 wherein forming the projection comprises forming only one projection when a thinnest sheet of the first sheet and the second sheet is equal to or less than 1.0 mm.

12. The method of claim 1 wherein forming the projection comprises forming only two projections when a thinnest sheet of the first sheet and the second sheet is equal to greater than 1.1 mm or less than or equal to 1.7 mm.

13. The method of claim 1 wherein forming the projection comprises forming three projections when a thinnest sheet of the first sheet and the second sheet is equal to or greater than 1.8 mm.

14. The method of claim 1 wherein placing the second sheet and the projection of the first sheet between electrodes of the welder comprises placing the second sheet and the projection of the first sheet between cylindrical electrodes of the welder.

15. The method of claim 1 wherein placing the second sheet and the projection of the first sheet between electrodes of the welder comprises placing the second sheet and the projection of the first sheet between electrodes of a resistance welder.

16. The method of claim 1 wherein welding the first sheet to the second sheet at the projection comprises welding the first sheet to the second sheet at the projection.

17. A method comprising;
providing a first sheet of material of non-liquid metal embrittlement susceptible material;
providing a second sheet of material of liquid metal embrittlement susceptible material;
providing a third sheet of material of liquid metal embrittlement susceptible material;
forming a first projection on first sheet in a first direction;
forming a second projection on the first sheet in a second direction opposite the first direction;
placing the first sheet between the second sheet and the third sheet so that the first projection is adjacent the second sheet and the second projection is adjacent the third sheet;
placing the first projection between electrodes of a welder;
placing the second projection between the electrodes of a welder; and
welding the first sheet to the second sheet and the third sheet.

18. The method of claim 17 wherein welding comprises welding the first sheet to the second sheet before welding the first sheet to the third sheet.

19. The method of claim 17 wherein welding comprises welding the first sheet to the second sheet simultaneously with welding the first sheet to the third sheet.

20. The method of claim 17 wherein welding the first sheet to the second sheet and the third sheet comprises forming a first weld nugget between the first projection and the second sheet and a second weld nugget between the second projection and the third sheet.
